(19) United States
(12) Patent Application Publication
(10) Pub. No.: US 2007/0284401 A1
(43) Pub. Date: Dec. 13, 2007

(54) Key charm apparatus

(76) Inventor: Alexander W. Hilliard, Odessa, FL (US)

Correspondence Address: LARSON AND LARSON, 11199 69TH STREET NORTH, LARGO, FL, 33773, US

(21) Appl. No.: 11/397,476

(22) Filed: May 26, 2006

(51) Int. Cl. B67D 5/08; G04C 23/00

(52) U.S. Cl. 222/638

(57) ABSTRACT

A key charm has a timer and a device for alerting a user. The timer is set to wake up after a period of time such as five-six hours; at which time the device for alerting the user is energized for a short period of time such as thirty seconds. The device for alerting the user is, for example, a vibrator, a sounder and/or a light. The key charm can be provided to an individual so that when it alerts the individual, the individual will think of someone or will think of an advertisement. Optionally, a mute button is provided to mute one or more of the vibrator, sounder and light.

### BACKGROUND OF THE INVENTION

1. Field of the Invention

This invention relates to the field of personal reminder devices and more particularly to a compact device for periodic reminders.

2. Description of the Related Art

There are many devices currently available to remind a person of important events. One such device is an alarm clock that signals the user at a preset time of day. The alarm clock can be in the form of a table-top device, a wristwatch or a pocket watch. Further, alarm clock functionality is often integrated into computer programs such as Microsoft Corporation's Outlook®, in which the user can program multiple reminders at various times throughout the day.

Furthermore, there are many electronic devices designed to be carried by a user in their pocket or on a keychain. These devices include garage door openers, pagers, cellular phones and small clocks. Some of these devices are designed to send one or more wireless signals. Some are communications devices. Some include electronic reminders. In all cases, the reminders must be programmed to a specific time of day. For example, U.S. Pat. No. 6,975,563 to de Brito describes a timepiece that can be worn or carried by the user and can accept data relating to an examination or test (time for the examination and number of questions), thereby pacing the user with a display and vibrating alerts so the user is paced through the examination. Unfortunately, this device is intended to alert the user only at pre-selected alert points and has no audible output at those alert points.

Another device that wakes up at random intervals is an electronic pet such as that described in U.S. Pat. No. 6,273,815 to Stuckman, et al. The electronic pet is designed to wake up at a random time and require feeding, care, playing, etc. Lack of response to its needs will cause the electronic pet to “die,” in that it may never wake again or it may require resetting to bring it back to life.

Unfortunately, the previous devices don't wake up to remind a person of another person, they don't vibrate and they don't allow the person to mute their noises without going through an elaborate process, for example pushing sequences of buttons to simulate feeding, care, playing, etc.

What is needed is a device that will remind a person at a random time of day by any combination of an audible signal, a visual signal and a vibration. The reminder may symbolize that they are important to another person, that the other person is thinking about them or it may be a corporate jingle. The reminder may be disabled, muted or partially muted by a simple push of a button.

### SUMMARY OF THE INVENTION

In one embodiment, a device for reminding is disclosed including a circuit contained within an enclosure, the circuit configured to generate a silent time period and a reminder time period, whereas the silent time period cannot be controlled externally. An alarm is coupled to the circuit and, responsive to the reminder time period, the alarm activates.

In another embodiment, a method of reminding a person is disclosed including internally setting a timer for a silent period then waiting for the timer to expire. When it expires, an alarm is enabled and then the timer is set for a reminder period. When the timer expires, the alarm is disabled and then the above steps are continuously repeating.

In another embodiment, an apparatus for reminding is disclosed including an enclosure and a circuit housed within the enclosure, the circuit including an oscillator for generating a first time period and a second time period. A device to alert is housed within the enclosure and operatively coupled to the oscillator whereby the device to alert is energized during the first time period only. A battery is also housed within the enclosure and operatively coupled to the circuit and to the device to alert, the battery configured to provide operational power.

### BRIEF DESCRIPTION OF THE DRAWINGS

The invention can be best understood by those having ordinary skill in the art by reference to the following detailed description when considered in conjunction with the accompanying drawings in which:

FIG. 1 illustrates a plan view of a first embodiment of the present invention.

FIG. 2 illustrates a plan view of an alternate embodiment of the present invention.

FIG. 3 illustrates a schematic diagram of the first embodiment of the present invention.

FIG. 4 illustrates a schematic diagram of the first embodiment of the present invention.

FIG. 5 illustrates a schematic diagram of the alternate embodiment of the present invention.

FIG. 6 illustrates a schematic diagram of a computer system implementing the first embodiment of the present invention.

FIG. 7 illustrates a flow chart of the computer system implementing the first embodiment of the present invention.

FIG. 8 illustrates a flow chart of the computer system implementing the alternate embodiment of the present invention.

FIG. 9 illustrates a sectional view of the present invention.

### DETAILED DESCRIPTION OF THE INVENTION

Reference will now be made in detail to the presently preferred embodiments of the invention, examples of which are illustrated in the accompanying drawings. Throughout the following detailed description, the same reference numerals refer to the same elements in all figures.

The key charm is a simple, portable, battery powered device. It has a timer that is set to signal the user at some time in the future, e.g., the silent period. The silent period is internally determined and is not controlled by the user. This silent period can be a fixed amount of time such as five hours or can be a random time range such as 4.5 hours to 6 hours. When the silent period expires, the key charm signals the user for another period of time, the reminder period (for example five seconds). After the reminder period, the key charm stops the signal until another silent period elapses, and so on. The signal or alarm may be audible such as a tone produced by a sounder such as a speaker or a piezoelectric transducer, visual such as a flashing indicator or may be a vibration created by energizing a motor that has an offset weight upon its shaft. In some embodiments, there is a mute button that stops any audible signal. In some embodiments, the mute button also stops the vibration. The key charm is sized to be small enough to be carried by a person in a pocket or in a pocketbook. In some embodiments, the audible signal is a simple tone. In other embodiments, it is a tune. In some embodiments, the tune is a corporate jingle such as the three note tune used by NBC Corporation. In that embodiment, the key charm might remind the owner to tune into NBC TV.

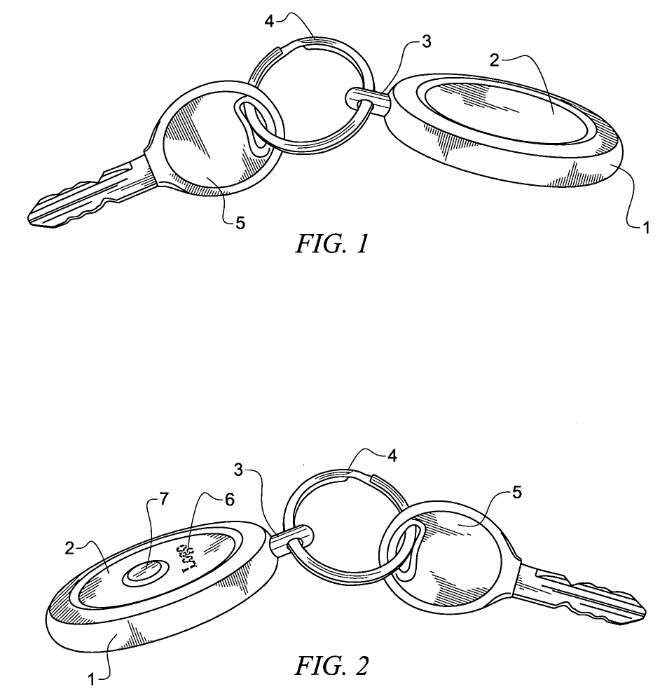

Referring to FIG. 1, a plan view of a first embodiment of the present invention is shown. In this, the key charm 1 is of oval shape and relatively thin so as to fit within a pocket, in a purse or on a necklace. In other embodiments, the key charm 1 is of any shape imaginable including pyramid, ball, cubic and the like. In the preferred embodiment, the key charm 1 has a slightly indented face 2 and an extension 3 through which a key ring 4 is attached and in some embodiments, one or more keys 5 are held by the key ring 4. In the preferred embodiment, the extension 3 is rotatably fastened to the key charm 1 so as to reduce tangling.

Referring to FIG. 2 a plan view of an alternate embodiment of the present invention is shown. In this, the key charm 1 is of oval shape and relatively thin so as to fit within a pocket, in a purse or on a necklace. In other embodiments, the key charm 1 is of any shape imaginable including pyramid, ball, cubic and the like. In the preferred embodiment, the key charm 1 has a slight indentation 2 and in this embodiment, there is a mute button 7 for muting the audible signal. In some embodiments, the face 2 has a logo or saying 6, for example, “I'm thinking about you.” An extension 3 allows the attachment of a key ring 4 and in some embodiments, one or more keys 5 are held by the key ring 4.

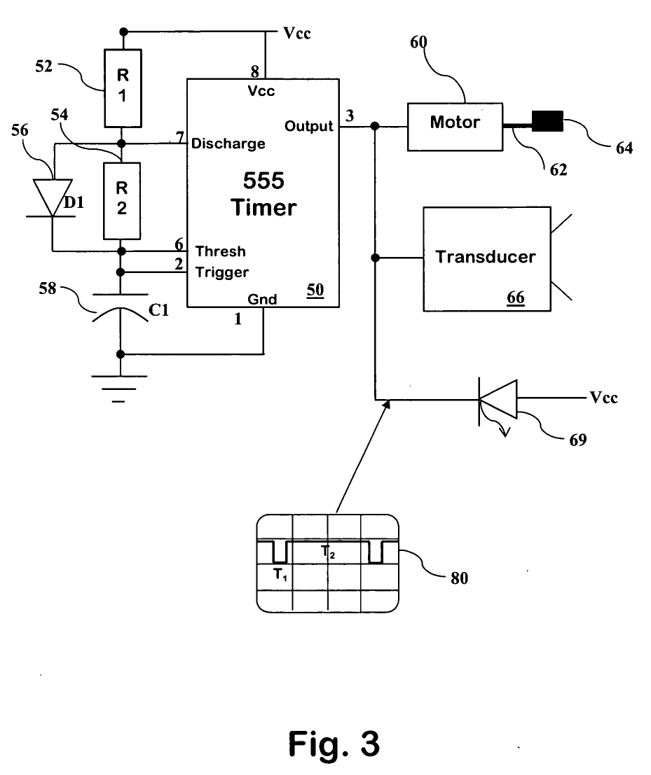

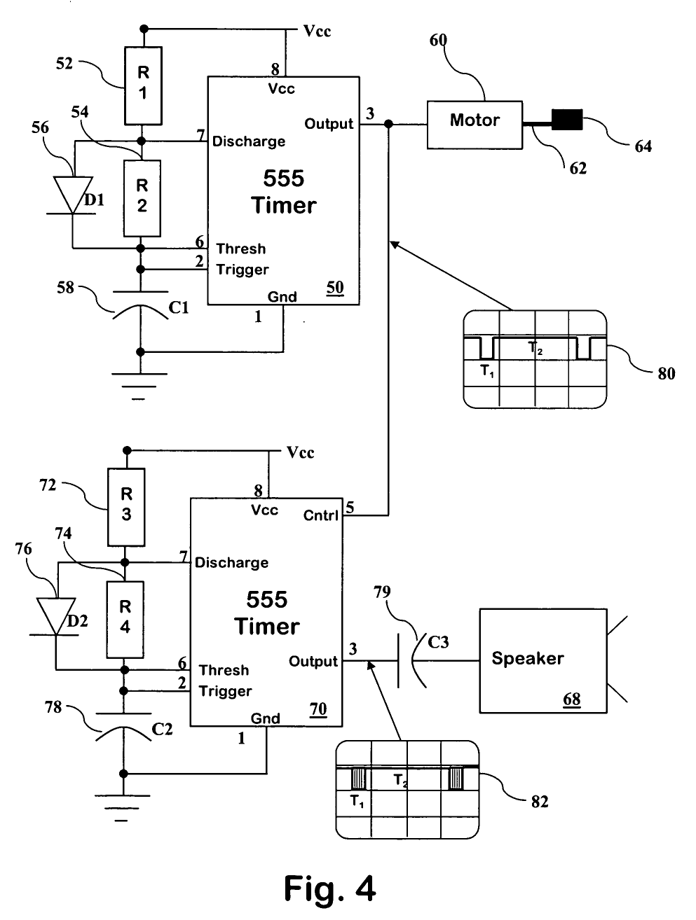

Referring to FIG. 3 a schematic diagram of the first embodiment of the present invention is shown. In this embodiment, an industry standard 555 timer 50 is employed to generate the silent period (T₂) and the reminder period (T₁). The circuit of FIG. 3 is a free running oscillator whose frequency is determined by R1 52, R2 54 and C1 58. R1 52 charges C1 58 through diode D1 56 until the voltage across C1 58 reaches a threshold at pin 6 of the 555 timer 50. At that point, the output of the 555 timer 50 goes low turning on the motor 60, thereby turning a shaft 62 upon which an offset weight 64 is mounted, thereby creating a vibration. Additionally, in some embodiments, the output of the 555 timer 50 is connected to a sounder or transducer 66 that emits a sound. Additionally, in some embodiments, the output of the 555 timer 50 is connected to a transducer that emits light such as an LED 69.

After the output of the 555 timer 50 goes low, the discharge output of the 555 timer 50 goes low and the capacitor C1 58 is discharged through R2 54 until its voltage drops to a point at which the 555 timer 50 resets and its output goes high and the motor 60 stops and the transducer 66 quiets and LED 69 extinguishes, the silent time (T₂). The silent time (T₂) is determined by the values of R1 52 and C1 58. The silent time (T₂) is approximately 0.69(R1*C1). The signaling period (T₁) is determined by the values of R2 54 and C1 58. The signaling period (T₁) is approximately 0.69(R2*C1). The output signal of the 555 timer 50 is shown on oscilloscope screen 80. For example, using a 18M resistor for R1 52, a 15K resistor for R2 54 and a 1000 uf capacitor for C1 56 yields a silent time (T₂) of approximately 3.5 hours and a signaling period (T₁) of approximately 10 seconds. By using low cost components, a range of randomness is introduces as temperature changes affect component values introducing ranges of silent time (T₂).

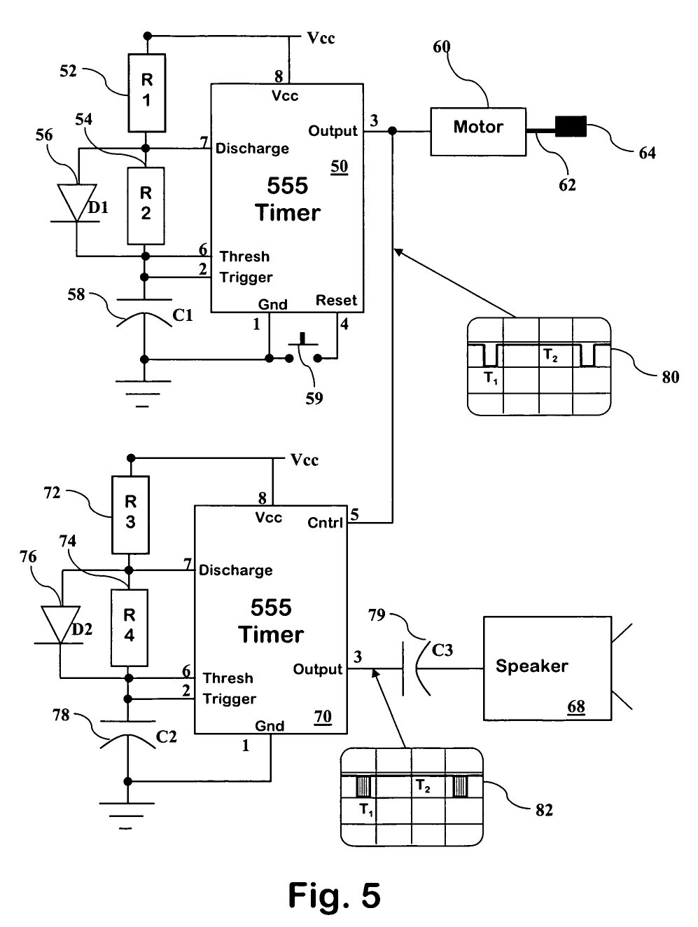

Referring to FIG. 4 an alternate schematic diagram of the first embodiment of the present invention is shown. In this embodiment, two industry standard 555 timers 50/70 are employed; the first 555 timer 50 generates the silent period (T₂) and the reminder period (T₁). The second 555 timer 70 is controlled by the first 555 timer 50 and generates an audible frequency at the speaker 68. The first 55 timer 50 is a free running oscillator whose frequency is determined by R1 52, R2 54 and C1 58. R1 52 charges C1 58 through diode D1 56 until the voltage across C1 58 reaches a threshold at pin 6 of the 555 timer 50. At that point, the output of the 555 timer 50 goes low turning on the motor 60, thereby turning a shaft 62 upon which an offset weight 64 is mounted, thereby creating a vibration. At this time, the discharge output of the 555 timer 50 goes low and the capacitor C1 58 is discharged through R2 54 until its voltage drops to a point at which the 555 timer 50 resets and its output goes high and the motor 60 stops and the transducer 66 quiets. The silent time (T₂) is determined by the values of R1 52 and C1 58. The silent time (T₂) is approximately 0.69 (R1*C1). The signaling period (T₁) is determined by the values of R2 54 and C1 58. The signaling period (T₁) is approximately 0.69 (R2*C1). The output signal of the 555 timer 50 is shown on oscilloscope screen 80. For example, using a 18 M resistor for R1 52, a 15K resistor for R2 54 and a 1000 uf capacitor for C1 56 yields a silent time (T₂) of approximately 3.5 hours and a signaling period (T₁) of approximately 10 seconds. By using low cost components, a range of randomness is introduced as temperature changes that affect the component's values introduce ranges of silent time (T₂).

Additionally, the output of the 555 timer 50 is connected to a second 555 timer 70. The second 555 timer 70 generates a frequency determined by R3 72, R4 74 and C2 78. For example, the second 555 timer 70 generates approximately a 725 Hz frequency if R3 72 and R4 74 are both 1 M ohm and C2 78 is 0.001 uf. D2 76 is not required, but provides a relative square wave signal. The output of the second 555 timer 50 is shown on oscilloscope 82, whereby its output is held high during T2 by the reset signal applied to its reset input coming from the first 555 timer 50 and its output is has a frequency within the audible range during T₁. Its output, in this embodiment, is coupled to a simple speaker 68 by a decoupling capacitor C3 79. AN exemplary value for C3 79 is 10 uf and the speaker 68 is 8 ohms in impedance. Note, the values shown are exemplary and many different values are possible without veering from the present invention. Furthermore, other circuits are well known in the industry and can achieve similar results. For example, instead of using two 555 timers 50/70, a dual 556 timer can be used or discrete transistors can be used to achieve similar results.

Referring to FIG. 5 a schematic diagram of the alternate embodiment of the present invention is shown. In this embodiment, two industry standard 555 timers 50/70 are employed as in FIG. 4; the first 555 timer 50 generates the silent period (T₂) and the reminder period (T₁). The second 555 timer 70 is controlled by the first 555 timer 50 and generates an audible frequency at the speaker 68. The first 555 timer 50 is a free running oscillator whose frequency is determined by R1 52, R2 54 and C1 58. R1 52 charges C1 58 through diode D1 56 until the voltage across C1 58 reaches a threshold at pin 6 of the 555 timer 50. At that point, the output of the first 555 timer 50 goes low turning on the motor 60, thereby turning a shaft 62 upon which an offset weight 64 is mounted, thereby creating a vibration. At this time, the discharge output of the first 555 timer 50 goes low and the capacitor C1 58 is discharged through R2 54 until its voltage drops to a point at which the first 555 timer 50 resets and its output goes high and the motor 60 stops and the transducer 66 quiets. The silent time (T₂) is determined by the values of R1 52 and C1 58. The silent time (T₂) is approximately 0.69(R1*C1). The signaling period (T₁) is determined by the values of R2 54 and C1 58. The signaling period (T₁) is approximately 0.69(R2*C1). The output signal of the first 555 timer 50 is shown on oscilloscope screen 80. For example, using a 18M resistor for R1 52, a 15K resistor for R2 54 and a 1000 uf capacitor for C1 56 yields a silent time (T₂) of approximately 3.5 hours and a signaling period (T₁) of approximately 10 seconds. By using low cost components, a range of randomness is introduces as temperature changes affect component values introducing ranges of silent time (T₂). This embodiment differs from the embodiment of FIG. 4 in that a normally open switch 59 is connected between ground and the reset input of the first 555 timer 50. Pressing the reset switch 59 resets the output of the first 555 timer 50, thereby stopping the motor 60 and disabling the second 555 timer 70. In some of embodiments, the switch 59 only mutes the audible output.

Additionally, the output of the first 555 timer 50 is connected to a second 555 timer 70. The second 555 timer 70 generates a frequency determined by R3 72, R4 74 and C2 78. For example, the second 555 timer 70 generates approximately a 725 Hz frequency if R3 72 and R4 74 are both 1 M ohm and C2 78 is 0.001 uf. D2 76 is not required, but provides a relative square wave signal. The output of the second 555 timer 50 is shown on oscilloscope 82, whereby its output is held high during T2 by the reset signal applied to its reset input from the first 555 timer 50 and a frequency within the audible range during T₁. Its output, in this embodiment, is coupled to a simple speaker 68 by a decoupling capacitor C3 79. AN exemplary value for C3 79 is 10 uf and the speaker 68 is 8 ohms in impedance.

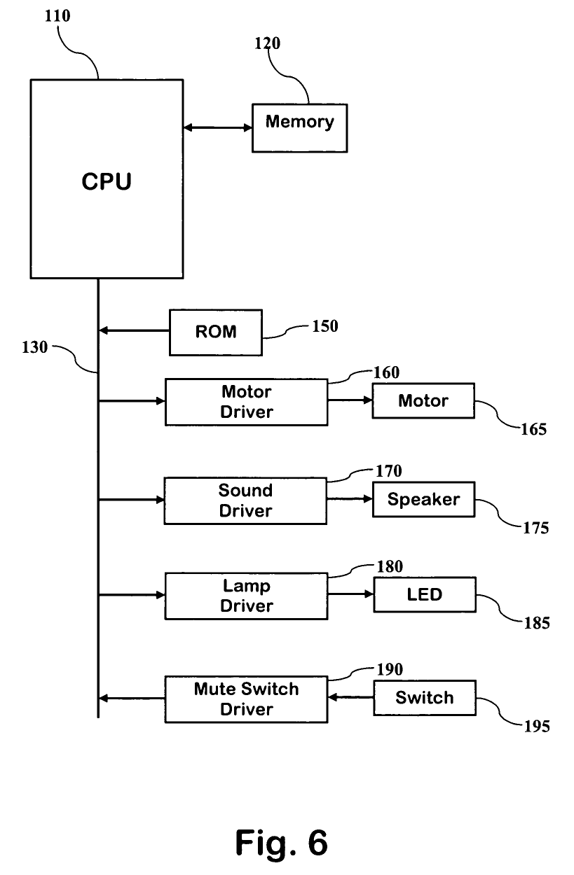

Referring to FIG. 6 a schematic diagram of a computer system implementing the first embodiment of the present invention is shown. In this embodiment, a low-power, low-cost micro-controller determines the silent period (T₂) and the signaling period (T₁). The micro-controller consists of a CPU 110 with memory 120 for storing temporary data and a ROM 150 for storing program instructions. In some embodiments, the ROM 150 is interfaced with the CPU 110 by a data bus 130. In an alternate embodiment, the ROM 150 is directly connected to the CPU 110, as there are many ways to configure a micro-controller and other configurations are possible without veering from the present invention. A motor driver 160 interfaces to the CPU 110 through the data bus 130. In some embodiments, the motor driver 160 is a programmable output pin of the CPU 110. The motor driver 160 is connected to a motor 165 that is similar to the motor system 60/62/64 of the prior figures. In some embodiments, a sound driver 170 is also connected to the data bus and is interfaced to a speaker or sounder 175 in ways known in the industry. A speaker emits a range of frequencies and generates more natural tunes while a sounder generates a fixed frequency but is controllable to generate a pre-programmed rhythm. In some embodiments, the sound driver 170 is a programmable output pin of the CPU 110. In some embodiments, the processor/CPU 110 generates a pre-programmed tune such as the NBC Corporate jingle. In that embodiment, the program would generate the tune by controlling the speaker or sounder 175 to follow a stored tune. The tune is stored in any way known in the industry including midi, wave, MP3, WMA, etc.

In some embodiments, a lamp driver 180 is also connected to the data bus and is interfaced to an indicator such as an LED 185 in ways known in the industry. In some embodiments, the lamp driver 180 is a programmable output pin of the CPU 110. In some embodiments, a mute switch driver 190 is also connected to the data bus and is interfaced to mute switch 195 in ways known in the industry. In some embodiments, the mute switch driver 190 is a programmable input pin of the CPU 110.

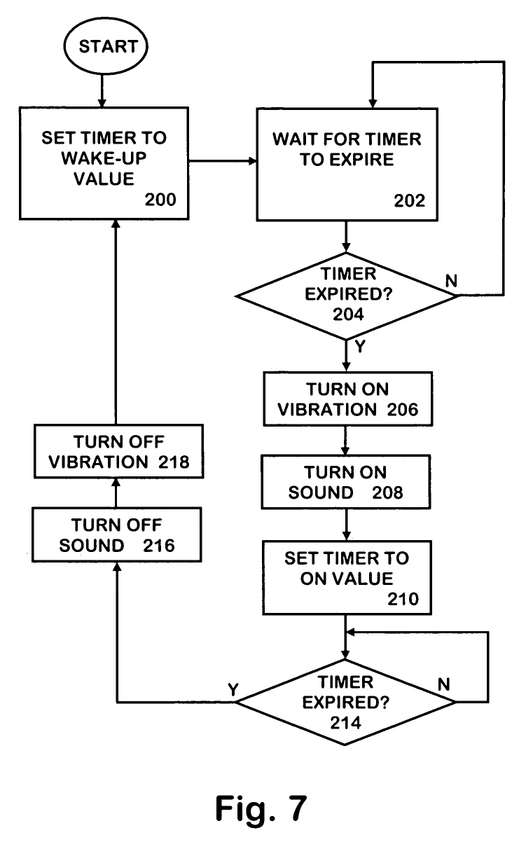

Referring to FIG. 7 a flow chart of the computer system implementing the first embodiment of the present invention is shown. When the CPU 110 is initially powered, the program starts by setting the wake-up timer to a wake-up value 200. In some embodiments, the wake-up value is a fixed amount of time, for example 5.5 hours. In other embodiments, the wake-up timer is a range of time. In some embodiments, the range of time is a base time, for example 5.5 hours plus a random or pseudo-random offset, for example zero to one hour yielding 5.5 hours to 6.5 hours. Random numbers are numbers that are hard to predict where as pseudo-random numbers are a repeating sequence whereby, not knowing where in the sequence the system is, it is hard to predict the next value. In either case, it will appear to the user that the wake-up time is unpredictable. Next, the program waits for the timer to expire 202/204 and once it expires, the program turns on the vibration 206 and sound 208. In some embodiments where there is a visual indicator, the lamp is turned on as well. Now the program sets the timer to the “on” value 210. This value may be a fixed amount of time, for example 5 seconds or may be randomized as above. When that timer expires 214, the sound 216 and vibration 218 are turned off and the process repeats starting with step 200. In some embodiments, the visual indicator is also turned off. In some embodiments, the sound is a pre-programmed tune such as the NBC Corporate jingle. In that embodiment, the program would generate the tune by controlling the sound device 208 to follow a stored tune. The tune is stored in any way known in the industry including midi, wave, MP3, WMA, etc.

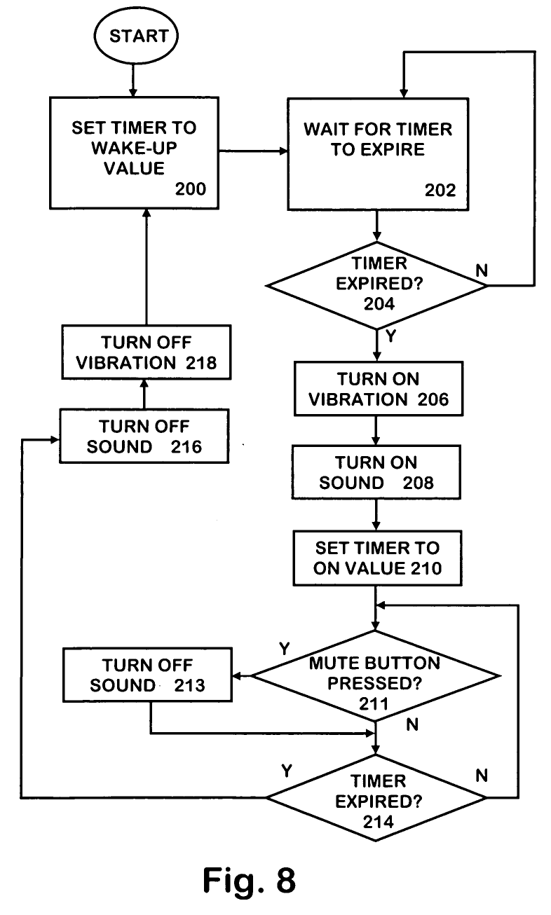

Referring to FIG. 8 a flow chart of the computer system implementing the alternate embodiment of the present invention is shown. This process is similar to that of FIG. 7, except for the introduction of a mute function. When the CPU 110 is initially powered, the program starts by setting the wake-up timer to a wake-up value 200. In some embodiments, the wake-up value is a fixed amount of time, for example 5.5 hours. In other embodiments, the wake-up timer is a range of time. In some embodiments, the range of time is a base time, for example 5.5 hours plus a random or pseudo-random offset, for example zero to one hour yielding 5.5 hours to 6.5 hours. Random numbers are numbers that are hard to predict where as pseudo-random numbers are a repeating sequence whereby, not knowing where in the sequence the system is, it is hard to predict the next value. In either case, it will appear to the user that the wake-up time is unpredictable. Next, the program waits for the timer to expire 202/204 and once it expires, the program turns on the vibration 206 and sound 208. In some embodiments where there is a visual indicator, the lamp is turned on as well. Now the program sets the timer to the “on” value 210. This value may be a fixed amount of time, for example 5 seconds or may be randomized as above. Now, the program checks to see if the mute button has been pressed 211. If the mute button has been pressed 211, step 213 is executed and the sound is turned off. Next, the timer is checked to see if the “on” time has expired 214. If not, the steps 211-214 are repeated. When the timer expires 214, the sound 216 and vibration 218 are turned off and the process repeats starting with step 200. In some embodiments, the visual indicator is also turned off.

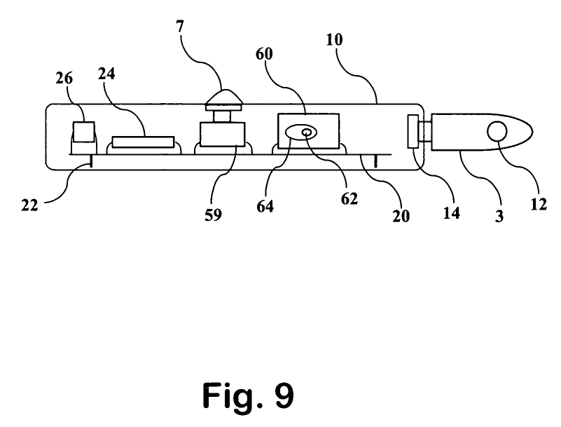

Referring to FIG. 9 a sectional view of the present invention is shown. The key charm has an enclosure 10 for holding the components. It is preferred that the enclosure 10 be water resistant to prevent moisture from harming the internal circuitry. Passing through an opening in the enclosure 10 is an extension 3 for attaching to a key ring by means of a hole 12. The extension is held within the enclosure 10 by a fastener 14. In some embodiments, the extension 3 is formed instead of having a fastener 14 such that when inserted into the enclosure 10, it is held in place by a larger surface 14 and allowed to freely rotate. It is preferred that the enclosure 10 be fabricated of two pieces that are glued, snapped or hot welded together. Components are mounted to a circuit board 20 and the circuit board 20 is held to the enclosure by means known in the industry, for example standoffs 22. A battery 26 is mounted to the circuit board 20 to provide power to the key charm. In some embodiments the battery is externally accessible and replaceable by the user. In some embodiments, a mute button 7 is coupled to a switch 59 on the circuit board 20 and operates as described above. In some embodiments, a motor 60 with shaft 62 and offset weight 64 is mounted to the circuit board 20. Other components are mounted to the circuit board 20, including, in some embodiments, a speaker or sounder 24.

Equivalent elements can be substituted for the ones set forth above such that they perform in substantially the same manner in substantially the same way for achieving substantially the same result.

It is believed that the system and method of the present invention and many of its attendant advantages will be understood by the foregoing description. It is also believed that it will be apparent that various changes may be made in the form, construction and arrangement of the components thereof without departing from the scope and spirit of the invention or without sacrificing all of its material advantages. The form herein before described being merely exemplary and explanatory embodiment thereof. It is the intention of the following claims to encompass and include such changes.

What is claimed is:

1. A device for reminding, the device comprising:
an enclosure;
a circuit contained within the enclosure, the circuit configured to generate a silent time period and a reminder time period, whereas the silent time period and the reminder time period are internally generated; and
an alarm operatively coupled to the circuit and responsive to the reminder time period, whereas the alarm is active during the reminder time period.

2. The device for reminding of claim 1, wherein the alarm is one or more devices selected from the group consisting of a vibrator, a sounder and a light.

3. The device for reminding of claim 1, wherein the circuit consists of at least one oscillator.

4. The device for reminding of claim 1, wherein the circuit consists of a processor wherein the silent time period and the reminder time period are generated by the processor.

5. The device for reminding of claim 4, wherein the silent time period generated by the processor consists of a fixed silent time period and a random offset period.

6. The device for reminding of claim 4, wherein the silent time period generated by the processor consists of a fixed silent time period and a pseudo-random offset period.

7. The device for reminding of claim 1, further comprising an extension, the extension being rotatably coupled to the enclosure, the extension having a hole for accepting a key ring.

8. The device for reminding of claim 2, further comprising a mute button operable from the outside of the enclosure, the mute button coupled to a mute switch, the mute switch configured to mute the sounder.

9. A method of reminding a person, the method comprising:
(1) internally setting a timer for a silent period;
(2) waiting for the timer to expire;
(3) enabling an alarm;
(4) setting the timer for a reminder period;
(5) waiting for the timer to expire;
(6) disabling the alarm; and
(7) repeating steps 1-7.

10. The method of reminding a person of claim 9, wherein in the step of internally setting the timer for the silent period, the silent period is calculated by adding a fixed time interval and a random offset time interval.

11. The method of reminding a person of claim 9, wherein in the step of internally setting the timer for the silent period, the silent period is calculated by adding a fixed time interval and a pseudo-random offset time interval.

12. The method of reminding a person of claim 9, wherein the alarm is selected from the group consisting of a vibrator, a sounder and a light.

13. The method of reminding a person of claim 9, further comprising during step 5, the steps of:
(5a) checking for the pressing of a mute button and if the mute button is pressed, disabling the alarm.

14. An apparatus for reminding, the apparatus comprising:
an enclosure means;
a circuit means housed within the enclosure means, the circuit means including a processor means, the processor means configured to generate a first time period and a second time period;
a means to alert housed within the enclosure means and operatively coupled to the processor means whereby the means to alert is energized during the first time period; and
a battery housed within the enclosure and operatively coupled to the circuit means and to the means to alert, the battery configured to provide operational power.

15. The device for reminding of claim 14, wherein the means to alert is one or more devices selected from the group consisting of a vibrator, a sounder, a speaker and a light.

16. The device for reminding of claim 14, further comprising an extension, the extension means being rotatably coupled to the enclosure means, the extension means having a means for accepting a device selected from the group consisting of a key ring and a necklace.

17. The device for reminding of claim 14, further comprising a mute button operable from outside of the enclosure means, the mute button coupled to a mute switch housed within the enclosure, the mute switch operatively coupled to the means to alert such that operation of the mute switch temporarily disables the means to alert.

18. The device for reminding of claim 15, further comprising a mute button operable from outside of the enclosure means, the mute button coupled to a mute switch housed within the enclosure, the mute switch operatively coupled to the sounder such that operation of the mute switch temporarily disables the sounder.

19. The device for reminding of claim 15, wherein the light is a light emitting diode (LED).

20. The device for reminding of claim 15, wherein the means to alert is a speaker and the processor means is configured to emit a preprogrammed tune to the speaker.
